(19) United States
(12) Patent Application Publication
(10) Pub. No.: US 2016/0163005 A1
(43) Pub. Date: Jun. 9, 2016

(54) Renewable Natural Gas Rights System and Method

(71) Applicant: The Energy Cooperative Association of Pennsylvania, Philadelphia, PA (US)

(72) Inventors: Joseph Fritz-Mauer, Wynnewood, PA (US); Clayton Thomas Bedwell, Philadelphia, PA (US)

(21) Appl. No.: 14/733,277

(22) Filed: Jun. 8, 2015

Related U.S. Application Data
(60) Provisional application No. 62/088,988, filed on Dec. 8, 2014.

(51) Int. Cl. G06Q 50/06; G06Q 30/06

(52) U.S. Cl. CPC G06Q 50/06; G06Q 30/06

(57) ABSTRACT

Systems and methods of providing renewable natural gas rights and acquiring the renewable natural gas rights are disclosed. More particularly, disclosed are systems and methods for managing natural gas, biogas, renewable natural gas credits, and other rights associated with purchasing, selling, and/or delivering natural gas to customers.

### CROSS REFERENCE TO RELATED APPLICATIONS

This application claims benefit of priority to U.S. Provisional Patent Application Ser. No. 62/008,988, filed Jun. 6, 2014, which is hereby incorporated by reference in its entirety.

### TECHNOLOGY FIELD

The present invention relates generally to the natural gas industry and, in particular, to systems and methods of providing renewable natural gas rights and acquiring the renewable natural gas rights.

### BACKGROUND

There are currently natural gas transmission systems that include gas pipelines spanning large areas (e.g., across the U.S.) which connect natural gas sources, such as natural gas production areas and natural gas storage areas, with natural gas end users or customers, such as homes, business and municipalities. Natural gas providers, such as utilities, may purchase a volume of natural gas from natural gas sources and provide and sell the natural gas to the end users. In some areas (e.g., states), individual entities may use the natural gas transmission systems to provide the natural gas to the end users in addition to utility companies. In many instances, however, the natural gas provided to the end users does not include gas from a renewable natural gas source.

Biogas production entities, such as landfills and waste treatment plants, produce biogas via the anaerobic digestion or fermentation of organic matter, such as for example, manure, sewage sludge, municipal solid waste, biodegradable waste or any other biodegradable feedstock. While the biogas may not be at the level for the natural gas pipeline (the natural gas transmission systems), the biogas is a renewable natural gas source that may be converted to a usable level. A more efficient and environmental friendly natural gas system is needed.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a diagram illustrating a natural gas pipeline system for use with embodiments of the present invention;

FIG. 2 is a diagram illustrating different ways of handling biogas from biogas sources for use with embodiments of the present invention;

FIG. 3 is a diagram illustrating an exemplary communication system for use with environmentally offsetting the providing of natural gas to end users for use with embodiments of the present invention;

FIG. 4 is a flow diagram illustrating an exemplary method of environmentally offsetting an amount of natural gas provided to end users by purchasing the environmental rights that correspond to an amount of renewable biogas;

FIG. 5 illustrates an example of a computing environment within which embodiments of the invention may be implemented; and

FIG. 6 is a system flow diagram illustrating a system for providing and acquiring renewable natural gas rights on a secondary market according to an exemplary embodiment.

### DETAILED DESCRIPTION OF ILLUSTRATED EMBODIMENTS

Embodiments of the invention include systems and methods of providing renewable natural gas rights and acquiring the renewable natural gas rights. In some embodiments, the renewable natural gas rights may be acquired by natural gas providers in a compliance market. For example, embodiments may include providing an amount of natural gas to end users and environmentally offsetting the provided amount of natural gas with the purchasing of environmental rights that correspond to an amount of renewable biogas produced by one or more biogas sources.

In other embodiments, the renewable natural gas rights may be bought and sold on a secondary (voluntary or compliance) market. For example, the secondary market of renewable natural gas rights may be facilitated by brokers, aggregators, and by one or multiple verification entities. For example, brokers may connect parties interested in buying or selling renewable natural gas rights, while aggregators may act as speculative purchasers of renewable natural gas rights. The transfer of renewable natural gas rights from a selling party to a buying party may be initiated by the selling party, such as through a standardized transfer method or portal maintained by a verification entity. In some embodiments, the purchase of renewable natural gas rights from the secondary market may be available to entities (e.g., companies) and individuals to serve both compliance markets and voluntary markets.

In some embodiments, the renewable natural gas rights may be bought and sold as a renewable natural gas credit (RNGC) that is equal to a portion of an amount of produced biogas. As used herein, “an amount of biogas” and an “amount of natural gas” may be measured in any type of measurable unit, such as units of volume (e.g., cubic feet), units of energy (e.g., BTUs or Joules) and units of power e.g., watts). In some embodiments of the invention, the environmental rights correspond to an amount of produced biogas having a gas quality level or an energy content (e.g., a medium British Thermal Unit (BTU) quality) that is less than a specified natural gas pipeline quality level. As used herein, “gas quality level” and “energy content level” both refer to the characterization of a particular gas stream. Those in the biogas industry will be familiar with the term “gas quality level” which generally indicates a range of energy content levels, often stated non-numerically such as “high BTU content,” “medium BTU content,” “low BTU content” or other designation as is common in the industry. Those in the natural gas industry will be more familiar with the term “energy content level” which is a more precise numerical notation, frequently in BTUs. Because this description spans both fields, both are used. In some embodiments of the invention, the environmental rights correspond to an amount of produced biogas having an energy content (e.g., a high BTU pipeline quality) that is substantially equal to a natural gas pipeline energy content level.

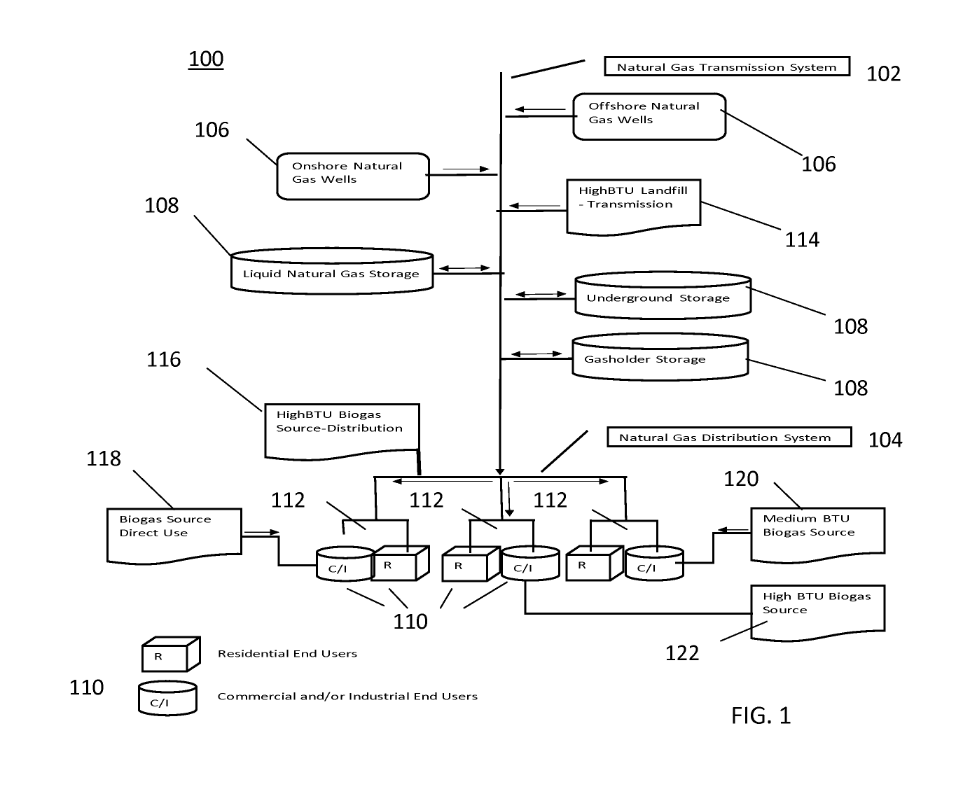

FIG. 1 is a diagram illustrating a natural gas pipeline system 100. As shown in FIG. 1, natural gas pipeline system 100 may include a natural gas transmission system 102 and a natural gas distribution system 104. Natural gas transmission system 102 may be made up of a network of gas pipelines which connect energy or natural gas production areas 106, natural gas storage areas 108 and high level (e.g., BTU level) transmission areas (e.g., landfill transmission area) to the natural gas distribution system 104, which distributes the natural gas to end users 110.

As shown in the embodiment at FIG. 1, natural gas production areas 106 may include both onshore natural gas wells and offshore natural gas wells. Natural gas production areas 106 may, however, include any entity or area that produces natural gas. As shown in the embodiment at FIG. 1, natural gas storage areas 108 include liquid natural gas storage areas, underground storage areas and gasholder storage areas. Natural gas storage areas may, however, include any storage area that stores natural gas.

As shown in the embodiment at FIG. 1, natural gas distribution system 104 may distribute the natural gas provided by the natural gas transmission system 102 to end users 110. End users 110 may include residential end users, commercial users and industrial end users. As shown in FIG. 1, the natural gas distribution system 104 may include sub-systems 112 that distribute the natural gas to the end users. As shown, some sub-systems 112 may distribute the natural gas to residential end users, commercial users and industrial end users, while other sub-systems 112 may distribute the natural gas to residential end users, while not distributing the natural gas to commercial users and industrial end users. Aspects of the embodiment may include sub-systems 112 that may distribute the natural gas to any one type of end user and any combination of end user types.

As described above, renewable biogases that have a lesser energy content (e.g., BTU level) than what is specified for the natural gas transmission system may be provided by biogas production sources, such as biogas production entities or biogas rights owners. As shown in FIG. 1, biogases may be provided to the end users 110 indirectly by: (i) high BTU landfill transmission 114 via the natural gas transmission system and the natural gas distribution system 102 and (ii) high BTU biogas source-distribution 116 via the natural gas distribution system 104. Biogases may also be provided directly to the end users 110 from direct use biogas source 118, medium BTU biogas source 120 and high BTU biogas source 122.

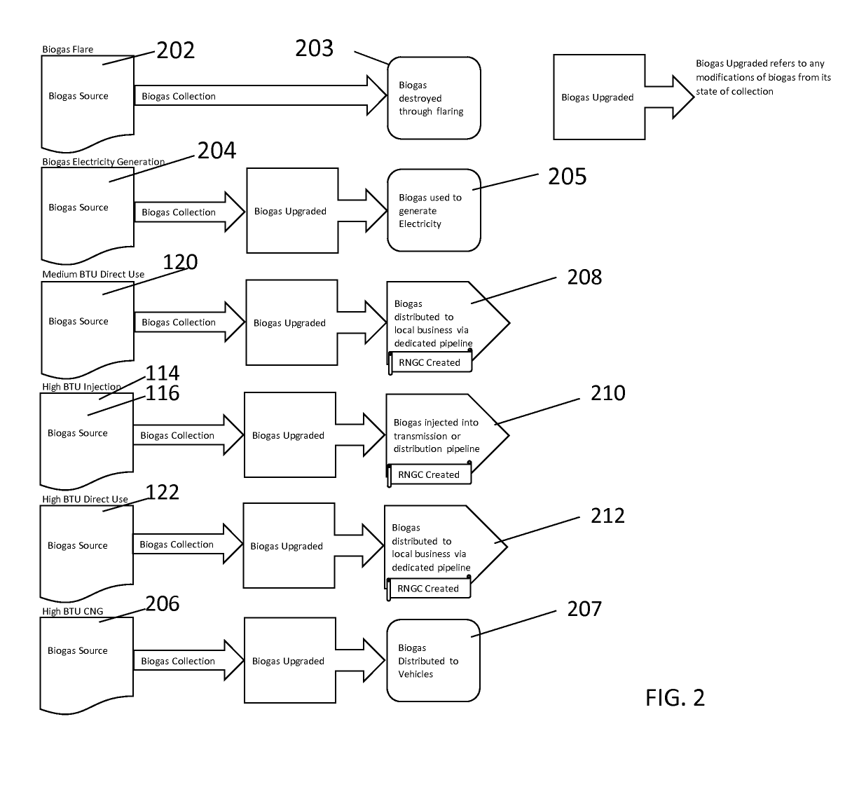

FIG. 2 is a diagram illustrating the plurality of different ways of handling the biogas from the biogas sources 114, 116, 120, 122, 202 and 204. Some biogas production sources (production entities or biogas owners) do not provide renewable natural gas sources because of the way they handle their biogases. The Environmental Protection Agency (EPA) provides a minimum regulation for biogas production sources (e.g., a landfill) to trap and burn the produced biogas, mitigating the effects of the greenhouse gases. Accordingly, some biogas production sources or companies that own the rights to the biogas (biogas owners), such as biogas production source 202 in FIG. 2, trap or collect the biogas gas and burn the gas in a process known as flaring as shown at block 203. Flaring the biogas wastes the biogas and does not provide a renewable natural gas resource.

Some biogas sources, such as biogas source 204 in FIG. 2, convert (or have converted by another entity) and upgrade the biogas to electricity as shown at block 205. The electricity may then be sold through a grid interconnection to the electricity grid (not shown).

Biogas sources, such as high BTU compressed natural gas (CNG) source 206, treat the biogas to a high BTU gas level (e.g., convert the biogas from a methane content of 50% to 98%), which is natural gas pipeline quality gas, but compress the biogas to CNG for use as a vehicle fuel, as shown in block 207 in FIG. 2.

Biogas sources, such as high BTU sources 114, 116 and 122 shown in FIG. 1 and FIG. 2, treat the biogas to a high BTU gas level as described above, to provide a renewable natural gas resource that may in turn be provided to end users 110. High BTU injection source 114 may inject the high BTU gas into the natural gas transmission system 102, as shown at block 210. The high BTU gas may then be sold to an end user 110 or a distributor, such as high BTU injection source 116 which may provide the high BTU gas directly to the natural gas distribution system 104, also shown at block 210. High BTU biogas source 122 may provide the high BTU gas directly to the end users 110, such as a local business via a dedicated local pipeline, as shown in block 212.

Biogas sources, such as biogas source 120 shown in FIG. 1 and FIG. 2, may treat (e.g., removing water and toxicities) the biogas to a usable level that is less than the BTU level of pipeline natural gas and provide the gas via a local pipeline that is not part of an integrated interstate or intrastate transmission or distribution pipeline system (not the natural gas pipeline) to an entity, such as a local business. For example, a biogas source may treat the biogas to produce a medium BTU level, which is about half the thermal value of pipeline gas. These methods of using the biogas do not include providing the biogas via the natural gas pipeline. This medium BTU biogas does, however, represent a renewable natural gas resource, albeit at a lower BTU level than a high BTU natural gas pipeline level.

Embodiments of the present invention utilize environmental rights that correspond to amount (volume or energy value) of renewable biogas produced from these one or more biogas sources, such as biogas sources 114, 116, 118, 120 and 122, to offset an amount of natural gas provided to end users.

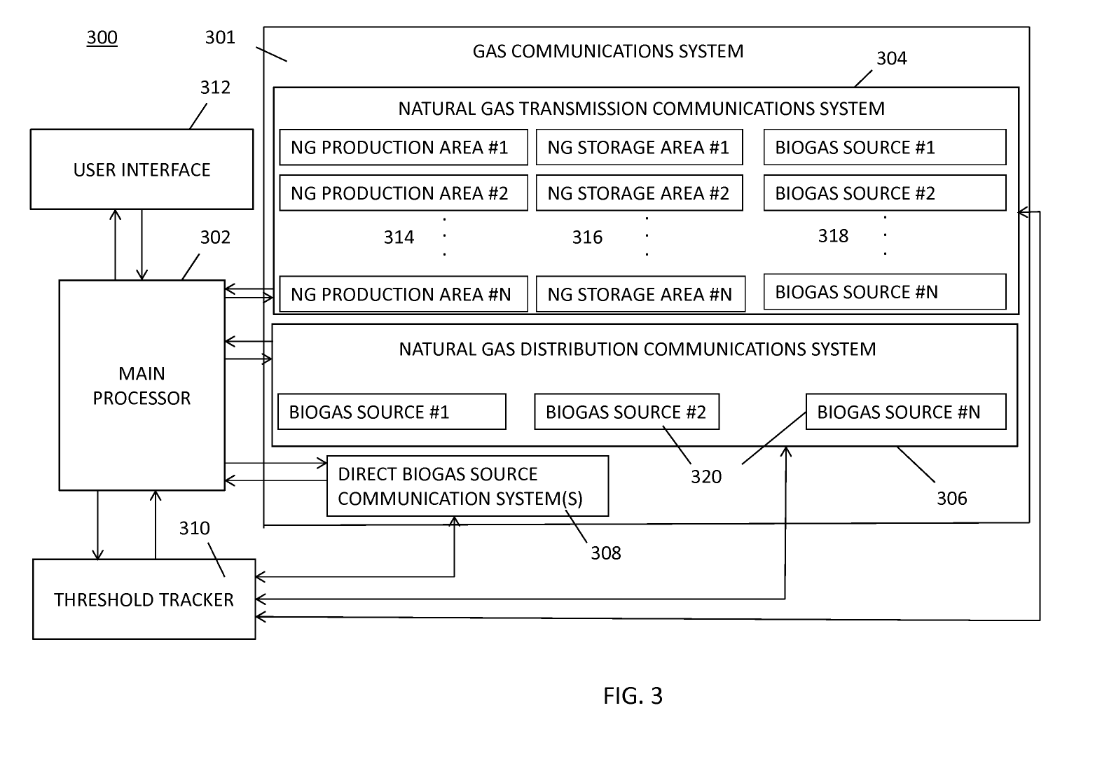

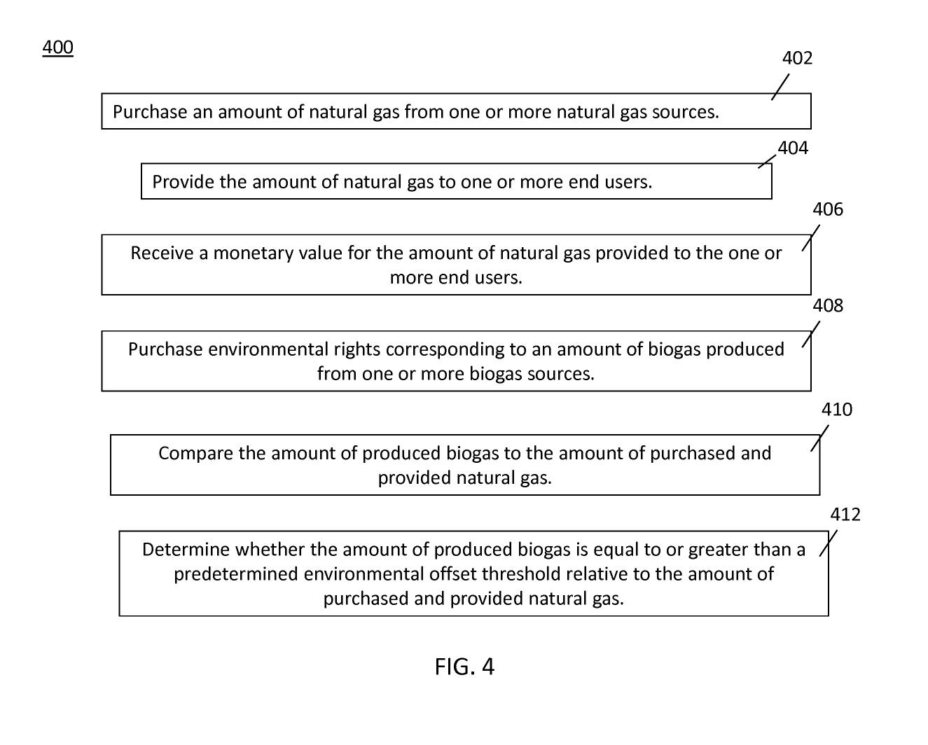

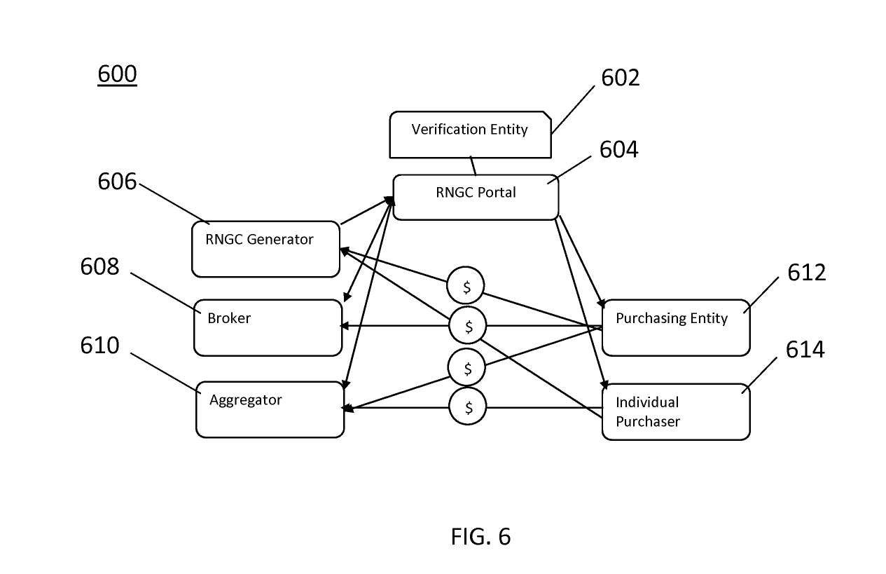

As described above, the renewable natural gas rights may be acquired (i) in a compliance market and (ii) in a voluntary market. FIG. 3 is a diagram illustrating an exemplary communication system for use with environmentally offsetting the providing of natural gas to end users in a compliance market. FIG. 4 is a flow diagram illustrating an exemplary method 400 of environmentally offsetting an amount of natural gas provided to end users in the compliance market. FIG. 6, which is described in more detail below, is a system flow diagram 600 illustrating the providing and acquiring of renewable natural gas rights on a voluntary market.

Referring now to FIG. 3, the communications system 300 may include a gas communication system 301 in communication with a main processor 302. Gas communication system 301 may include a natural gas transmission communication system 304, a natural gas distribution communication system 306 and one or more direct biogas source communication systems 308. The natural gas transmission communication system 304 may include one or more natural gas production areas communication systems 314, one or more natural gas storage areas communication systems 316 and one or more biogas source communication systems 318. Natural gas distribution communication system 306 may include one or more biogas source communication systems 320.

In the compliance market, gas communication system 301 may be configured to monitor (i) an amount of natural gas purchased by a natural gas provider and (ii) environmental rights purchased by the natural gas provider. The environmental rights correspond to an amount of biogas produced from one or more biogas sources. The amount of natural gas purchased by a natural gas provider may be monitored via the one or more natural gas production areas communication systems 314 and/or the one or more natural gas storage areas communication systems 316. The amount of biogas produced may be monitored via the one or more biogas source communication systems 318, the one or more biogas source communication systems 320 and one or more direct biogas source communication systems 308. Communications system 300 may also include a threshold tracker 310 in communication with main processor 302. Threshold tracker 310 may also be in direct communication with natural gas transmission communication system 304, natural gas distribution communication system 306 and one or more direct biogas source communication systems 308. Communications system 300 may also include a user interface 312 in communication with main processor 302.

Referring now to FIG. 4, as shown at block 402, the method 400 may include purchasing, via a processor, an amount of natural gas from one or more natural gas sources 106 and 108. In some embodiments, purchasing an amount of natural gas may include purchasing ownership rights, such as the rights to sell, transfer, or assign the amount of natural gas. In some embodiments, the amount of natural gas purchased may be selected using the user interface 312. The amount of natural gas purchased from the one or more natural gas sources 106 and 108 may be communicated to main processor 302 from one or more natural gas production areas communication systems 314 and one or more natural gas storage areas communication systems 316. The amount of natural gas purchased may be stored and used to compare to an amount of biogas corresponding to purchased environmental rights, as described below. The stored amount of purchased natural gas may also be used to provide the amount to end users 110.

As shown at block 404, the method 400 may include providing, via the main processor 302, the amount of natural gas to one or more end users. Because natural gas provided by each natural gas source is combined into the natural gas transmission system 102, the natural gas provided to the one or more end users 110 is not the actual natural gas purchased from the natural gas source. The provided amount of natural gas, however, remains the same as the purchased amount. In some embodiments, the amount of natural gas provided to the end users 110 may be selected using the user interface 312.

As shown at block 406, the method 400 may include receiving, via the main processor 302, a monetary value for the amount of natural gas provided to the one or more end users 110.

As shown at block 408, the method 400 may include purchasing, via the main processor 302, environmental rights corresponding to an amount of biogas produced from one or more biogas sources 114, 116, 118 and 120. The amount of biogas produced by the biogas sources 114, 116, 118 and 120 may be communicated to the main processor 302 from the one or more biogas source communication systems 318, the one or more biogas source communication systems 320 and one or more direct biogas source communication systems 308. The amount of biogas produced by the one or more biogas sources may be communicated to the main processor 302 via threshold tracker 310. Main processor 302 may also communicate the amount of biogas produced to threshold tracker 310 after receiving the amount of biogas produced from communication systems 318, 320 and 308. Threshold tracker 310 may be configured to communicate one or more predetermined environmental offset thresholds to the processor 302 and receive an indication from the processor 302 of whether the amount of biogas produced by the one or more biogas sources 114, 116, 118 is equal to or greater than the one or more predetermined environmental offset thresholds. For example, a threshold may be changed or added to the system 300 and communicated to the processor 302 from threshold tracker 310. In some embodiments, the predetermined offset thresholds may be regulated by a government agency and predetermined offset thresholds may be monitored and provided to threshold tracker 310 by the government agency.

As shown at block 410, the method 400 may include comparing, via the main processor 302, the amount of biogas produced by the biogas sources 114, 116, 118 and 120 to the amount of natural gas purchased from the one or more natural gas sources 106 and 108 and provided to end users 110. As shown at block 412, the method 400 may include determining, via the processor 302, whether the amount of biogas produced by the biogas sources 114, 116, 118 is equal to or greater than a predetermined environmental offset threshold relative to the amount of natural gas purchased from the natural gas sources 106 and 108. In some embodiments, threshold tracker 310 may be used to determine whether the amount of biogas produced by the biogas sources 114, 116, 118 is equal to or greater than a predetermined environmental offset threshold relative to the amount of natural gas purchased from the natural gas sources 106 and 108.

An amount of biogas and an amount of natural gas may be measured in any type of measurable unit, such as units of volume (e.g., cubic feet), units of energy (e.g., BTUs or Joules) and units of power (e.g., watts).

For example, in one embodiment, the amount of natural gas and the amount of biogas are measured by units of energy. Units of volume may be measured in any units of energy, such as BTUs or Joules. Accordingly, main processor 302 may also determine whether a number of BTUs of biogas produced by the biogas sources 114, 116, 118 is equal to or greater than a predetermined environmental offset threshold relative to the number of BTUs of natural gas purchased from the natural gas sources 106 and 108.

In another embodiment, the amount of natural gas and the amount of biogas are measured by volume. Units of volume may be measured in the International System of Units (SI), such as cubic meters. Units of volume may be measured in other units, such as Imperial units (e.g., cubic feet). Accordingly, main processor 302 may determine whether the volume of biogas produced by the biogas sources 114, 116, 118 is equal to or greater than a predetermined environmental offset threshold relative to the volume of natural gas purchased from the natural gas sources 106 and 108. The amount of natural gas and the amount of biogas may also be measured in units of flow volume as a function of time, such as cubic meters per second or cubic feet per second.

According to another embodiment, the amount of natural gas and the amount of biogas are measured by Carbon Content. Natural gas is mainly comprised of methane (CH₄). The mass of carbon present in gas can be measured based on the methane content. The mass of carbon present (methane) in natural gas served through the transmission and distribution system can be used to determine the necessary volume of biogas needed to act as offset. Carbon is emitted when gas is combusted. The use of fossil gas emits carbon previously sequestered by nature and thus contributes to the greenhouse gas effect. The carbon contained in biogas is part of the present carbon cycle. The combustion of biogas releases this carbon that was previously extracted from the atmosphere by the natural processes. Thus, there are greenhouse gas emissions reductions from the combustion of biogas.

In one embodiment, the amount of natural gas and the amount of biogas are measured in a currency unit (e.g., U.S. dollars). The cost of the load served through the natural gas transmission system 102 and the natural gas distribution system 104, may be used to determine the cost allocated to purchasing biogas offsets.

A renewable natural gas credit (RNGC) may be referred to as tradable, no tangible energy commodities that represent rights, title and/or interest in and to the environmental attributes associated with the application of a predetermined amount of natural gas. In one embodiment, a portion of the amount of the biogas is equal to a RNGC and the predetermined environmental offset threshold may be equal to one or more RNGCs. In some embodiments, the amount of biogas is equivalent to a partial RNGC, a single RNGC, or multiple RNGCs. The processor may determine the appropriate relationship between the amount of the biogas and the RNGCs. For example, in one embodiment, one RNGC may be assigned to correspond to an amount of biogas. As described above, an amount of biogas may be measured in any type of measurable unit, such as units of volume (e.g., cubic feet), units of energy (e.g., BTUs) and units of power (e.g., watts). For example, one NGC may be assigned to correspond to an amount of one million BTUs of biogas.

In one embodiment, the predetermined environmental offset threshold may be equal to a percentage or ratio and the processor 302 may determine whether the amount of biogas purchased from the biogas sources 114, 116, 118 is equal to or greater than a percentage of the amount of natural gas purchased from the natural gas sources 106 and 108.

A pre-determined offset percentage threshold may range anywhere from 1% to 100% of the amount of natural gas purchased. The pre-determined offset percentage threshold may be determined according to many factors, including how a natural gas provider may be commercially labeled or indicated to end users 110. For example, natural gas providers may be indicated as a “green natural gas provider” to end users if the amount of biogas purchased from the biogas sources 114, 116, 118 is equal to or greater than a predetermined percentage (e.g., 25%). In some embodiments, natural gas providers may also be grouped into tiers relative to their environmental offsets, such as for example: (1) “a high green natural gas provider” if equal to or greater than 50%; (2) “a medium green natural gas provider” if between 25% and 50% and (3) “a minimum green natural gas provider” if between 1% and 25%. Embodiments may include any number of tiers corresponding to any percentages.

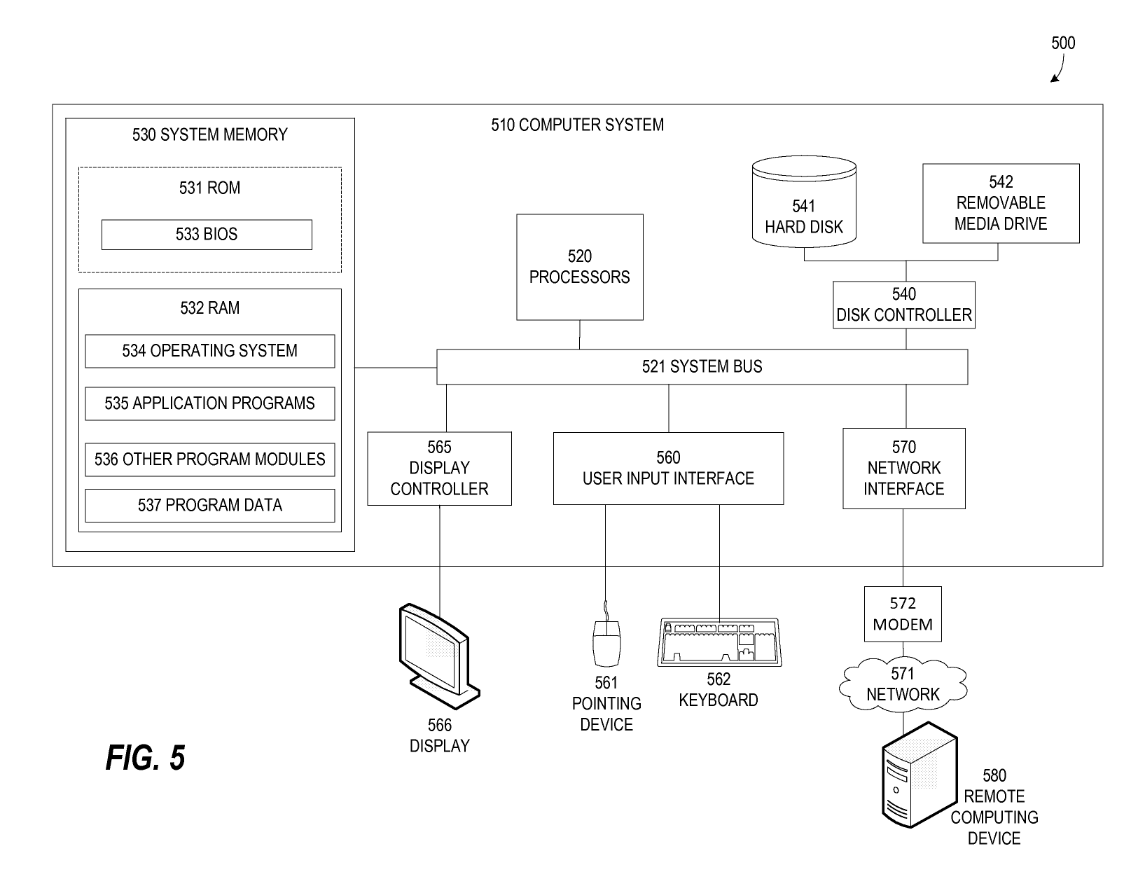

FIG. 5 illustrates an example of a computing environment 500 within which embodiments of the invention may be implemented. Computing environment 500 may include computer system 510, which is one example of a computing system upon which embodiments of the invention may be implemented. As shown in FIG. 5, the computer system 510 may include a communication mechanism such as a bus 521 or other communication mechanism for communicating information within the computer system 510. The system 510 further includes one or more processors 520 coupled with the bus 521 for processing the information. The processors 520 may include one or more CPUs, GPUs, or any other processor known in the art.

The computer system 510 also includes a system memory 530 coupled to the bus 521 for storing information and instructions to be executed by processors 520. The system memory 530 may include computer readable storage media in the form of volatile and/or nonvolatile memory, such as read only memory (ROM) 531 and/or random access memory (RAM) 532. The system memory RAM 532 may include other dynamic storage device(s) (e.g., dynamic RAM, static RAM, and synchronous DRAM). The system memory ROM 531 may include other static storage device(s) (e.g., programmable ROM, erasable PROM, and electrically erasable PROM). In addition, the system memory 530 may be used for storing temporary variables or other intermediate information during the execution of instructions by the processors 520. A basic input/output system 533 (BIOS) containing the basic routines that help to transfer information between elements within computer system 510, such as during start-up, may be stored in ROM 531. RAM 532 may contain data and/or program modules that are immediately accessible to and/or presently being operated on by the processors 520. System memory 530 may additionally include, for example, operating system 535, application programs 535, other program modules 536 and program data 537.

The computer system 510 also includes a disk controller 540 coupled to the bus 521 to control one or more storage devices for storing information and instructions, such as a magnetic hard disk 541 and a removable media drive 542 (e.g., floppy disk drive, compact disc drive, tape drive, and/or solid state drive). The storage devices may be added to the computer system 510 using an appropriate device interface (e.g., a small computer system interface (SCSI), integrated device electronics (IDE), Universal Serial Bus (USB), or FireWire).

The computer system 510 may also include a display controller 565 coupled to the bus 521 to control a display or monitor 566, such as a cathode ray tube (CRT) or liquid crystal display (LCD), for displaying information to a computer user. The computer system includes an input interface 560 and one or more input devices, such as a keyboard 562 and a pointing device 561, for interacting with a computer user and providing information to the processor 520. The pointing device 561, for example, may be a mouse, a trackball, or a pointing stick for communicating direction information and command selections to the processor 520 and for controlling cursor movement on the display 566. The display 566 may provide a touch screen interface which allows input to supplement or replace the communication of direction information and command selections by the pointing device 561.

The computer system 510 may perform a portion of or all of the processing steps of embodiments of the invention in response to the processors 520 executing one or more sequences of one or more instructions contained in a memory, such as the system memory 530. Such instructions may be read into the system memory 530 from another computer readable medium, such as a hard disk 541 or a removable media drive 542. The hard disk 541 may contain one or more datastores and data files used by embodiments of the present invention. Datastore contents and data files may be encrypted to improve security. The processors 520 may also be employed in a multi-processing arrangement to execute the one or more sequences of instructions contained in system memory 530. In alternative embodiments, hard-wired circuitry may be used in place of or in combination with software instructions. Thus, embodiments are not limited to any specific combination of hardware circuitry and software.

As stated above, the computer system 510 may include at least one computer readable medium or memory for holding instructions programmed according to embodiments of the invention and for containing data structures, tables, records, or other data described herein. The term “computer readable medium” as used herein refers to any non-transitory, tangible medium that participates in providing instructions to the processor 520 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 541 or removable media drive 542. Non-limiting examples of volatile media include dynamic memory, such as system memory 530. Non-limiting examples of transmission media include coaxial cables, copper wire, and fiber optics, including the wires that make up the bus 521. Transmission media may also take the form of acoustic or light waves, such as those generated during radio wave and infrared data communications.

The computing environment 500 may further include the computer system 510 operating in a networked environment using logical connections to one or more remote computers, such as remote computer 580. Remote computer 580 may be a personal computer (laptop or desktop), a mobile device, a server, a router, a network PC, a peer device or other common network node, and typically includes many or all of the elements described above relative to computer 510. When used in a networking environment, computer 510 may include modem 572 for establishing communications over a network 571, such as the Internet. Modem 572 may be connected to system bus 521 via user network interface 570, or via another appropriate mechanism.

Network 571 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 510 and other computers (e.g., remote computing system 580). The network 571 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 571.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display images, generated by a display processor and enabling user interaction with a processor or other device and associated data acquisition and processing functions.

The GUI also includes an executable procedure or executable application. The executable procedure or executable application conditions the display processor to generate signals representing the GUI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the GUI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of the figures presented herein are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, the processes and applications may, in alternative embodiments, be located on one or more (e.g., distributed) processing devices on a network linking the units of FIG. 5. Any of the functions and steps provided in the Figures may be implemented in hardware, software or a combination of both. No claim element herein is to be construed under the provisions of 35 U.S.C. 112, sixth paragraph, unless the element is expressly recited using the phrase “means for.”

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

FIG. 6 is a system flow diagram illustrating a system 600 for providing and acquiring renewable natural gas rights on a voluntary market according to an exemplary embodiment. As shown in FIG. 6, the system 600 may include a verification entity 602, an RNGC portal 604, a RNGC generator 606, a broker 608, an aggregator 610, a purchasing entity 612 (e.g., a company) and an individual purchaser 614. The embodiment shown at FIG. 6 includes the providing and acquiring of RNGCs. Embodiments may, however, include a secondary market that provides renewable natural gas rights other than RNGCs.

As shown in FIG. 6, RNGCs may be generated by RNGC generator 606, provided to the RNGC portal 604 and verified by verification entity 602. The RNGCs may then be provided to broker 608, aggregator 610, purchasing entity 612 and/or an individual purchaser 614. A monetary value may be provided by purchasing entity 612 and/or an individual purchaser 614 to the RNGC generator 606, broker 608, or aggregator 610 to acquire the RNGCs.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A computer implemented method of providing natural gas to end users, the method comprising:
purchasing, via a processor, an amount of natural gas from one or more natural gas sources;
providing the amount of natural gas to one or more end users;
receiving a monetary value for the amount of natural gas provided to the one or more end users;
purchasing, via the processor, environmental rights corresponding to an amount of biogas produced from one or more biogas sources, the biogas having a gas energy content that is equal to or less than the natural gas energy content level; and
determining, via the processor, whether the amount of biogas produced by the one or more biogas sources is equal to or greater than a predetermined environmental offset threshold relative to the amount of natural gas purchased from the one or more natural gas sources.

2. The computer implemented method of claim 1, wherein the amount of natural gas and the amount of biogas are measured in units of energy.

3. The computer implemented method of claim 1, wherein the amount of natural gas and the amount of biogas are measured in units of volume.

4. The computer implemented method of claim 1, wherein purchasing an amount of natural gas comprises purchasing ownership rights to an amount of natural gas.

5. The computer implemented method of claim 1, further comprising:
establishing a renewable natural gas credit as equivalent to a predetermined amount of the biogas, wherein
the predetermined environmental offset threshold is equal to one or more renewable natural gas credits, and
the determining, by the processor, further comprises determining whether the amount of the biogas purchased is equal to or greater than the one or more renewable natural gas credits.

6. The computer implemented method of claim 1, wherein
the predetermined environmental offset threshold is equal to a percentage of the amount of natural gas purchased from the one or more natural gas providers, and
the determining, by the processor, further comprises determining whether the amount of biogas purchased from the one or more biogas sources is equal to or greater than the percentage of the amount of natural gas purchased from the one or more natural gas providers.

7. The computer implemented method of claim 1, further comprising comparing, via the processor, the amount of biogas produced by the one or more biogas sources to the amount of natural gas purchased from the one or more natural gas sources.

8. A communication system for verifying an environmental offset when providing natural gas to end users, the communication system comprising:
a gas communication system configured to monitor (i) an amount of natural gas purchased by a natural gas provider and (ii) environmental rights purchased by the natural gas provider, the environmental rights corresponding to an amount of biogas produced from one or more biogas sources;
a processor configured to:
purchase the amount of natural gas from one or more natural gas sources;
provide the amount of natural gas to one or more end users;
receive a monetary value for the amount of natural gas provided to the one or more end users;
purchase the environmental rights corresponding to the amount of biogas produced from the one or more biogas sources;
compare the amount of biogas purchased from the one or more biogas sources to the amount of natural gas purchased from the one or more natural gas providers; and
determine whether the amount of biogas produced by the one or more biogas sources is equal to or greater than a predetermined environmental offset threshold relative to the amount of natural gas purchased from the one or more natural gas sources.

9. The communication system according to claim 8, wherein the gas communication system further comprises:
a natural gas transmission communication system having: (i) one or more natural gas production area communication systems and one or more natural gas storage areas communication systems configured to monitor and communicate the amount of natural gas purchased by the natural gas provider; and (ii) one or more biogas source communication systems configured to monitor and communicate the amount of biogas produced from the one or more biogas sources corresponding to the purchased environmental rights;
a natural gas distribution communication system having one or more biogas source communication systems configured to monitor and communicate the amount of biogas produced from the one or more biogas sources corresponding to the purchased environmental rights; and
one or more direct biogas source communication systems configured to monitor and communicate the amount of biogas produced from the one or more biogas sources corresponding to the purchased environmental rights.

10. The communication system according to claim 8, further comprising a threshold tracker configured to: (i) communicate one or more predetermined environmental offset thresholds to the processor and receive an indication from the processor of whether the amount of biogas produced by the one or more biogas sources is equal to or greater than the one or more predetermined environmental offset thresholds.

11. The communication system according to claim 8, wherein the biogas has a gas quality level that is equal to or less than the natural gas quality level.
